(19) United States
(12) Patent Application Publication
(10) Pub. No.: US 2003/0210285 A1
(43) Pub. Date: Nov. 13, 2003

(54) Information processing apparatus and method of controlling the same

(75) Inventor: Fujihito Numano, Hamura-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/425,747

(22) Filed: Apr. 30, 2003

(30) Foreign Application Priority Data
May 8, 2002 (JP) 2002-133050

(51) Int. Cl. G09G 5/00

(52) U.S. Cl. 345/856; 345/754

(57) ABSTRACT

An information processing apparatus comprises a first display, a pointing device having a second display, an operation input controller which reflects a pointing operation of the pointing device to a mouse pointer displayed on the first display, and a first entire screen display controller which displays on the second display a first image of a virtual screen which is larger that a screen of the first display.

### CROSS-REFERENCE TO RELATED APPLICATIONS

This application is based upon and claims the benefit of priority from the prior Japanese Patent Application No. 2002-133050, filed May 8, 2002, the entire contents of which are incorporated herein by reference.

### BACKGROUND OF THE INVENTION

1. Field of the Invention

The present invention relates to an information processing apparatus such as a portable personal computer comprising, for example, a touch pad type pointing device with a display screen, and also to a method of controlling such an information processing apparatus.

2. Description of the Related Art

Various portable personal computers of the notebook type, or the laptop type, have been developed in recent years. Portable personal computers are equipped with various functional features which provide the user with an enhanced level of operability.

Such functional features include a touch pad type tablet device (pointing device) which replaces the mouse of a portable personal computer. Known touch pad type tablet devices such as a device disclosed in Japanese Patent Publication (KOKAI) No. 8-44493 are being widely used as pointing devices. With a touch pad type tablet device, the user can perform various operations on the tablet such as moving a mouse pointer and selecting one of display buttons typically by doing pointing operations including touch operations and tapping operations.

There are more currently available functional features which provide the user with a high level of operability.

They include a virtual display feature. With a virtual display feature, it is possible to provide a virtual display screen on a desk top which is by far larger than the actual display screen of the display device.

With the virtual display feature, only a part of the image on the virtual display screen is shown on the actual display screen (real display screen) of the display device. The image which is being displayed on the real display image, which is a part of the image being displayed on the virtual display screen, can be shifted by moving the mouse pointer to an edge of the real display screen. This operation is referred to a “panning operation.”

The virtual display feature further includes a multi-display system. The multi-display system is a technique for displaying different images respectively on the display screens of the two display devices including, for example, the internal display device and the external display device of a portable personal computer. The two display regions are specified on the virtual display screen and the images of the two display regions are displayed respectively on the display screens of the two display devices.

Efforts have been and being paid to increase the dimensions (resolution) of the virtual display screen which can be used for displaying an image on the basis of the improved performance of the graphic chip and the increased capacity of the video memory which are mounted on a computer. As a result, the user can display a large number of application windows on the large virtual display screen for processing operations.

Given the above technological advancement, however, only a part of the image that is displayed on the virtual display screen can be displayed on each of the real display screens as before. In other words, as the dimensions (resolution) of the virtual display screen are increased, the user feels it difficult to grasp the whole image which is being displayed on the entire virtual display screen.

When the user wants to do a processing operation on an application window which is not being displayed on the real display screen, he or she is required to do a panning operation. As the user does a panning operation, the display region of the image which is being displayed on the selected one of the real display screens moves continuously on the virtual display screen. In other words, after the panning operation, the application window which was being displayed on the selected real display screen before the panning operation may have been hidden and no longer visible. Therefore, there is required a device for displaying on the real display screen the image in a desired one of the application windows on the virtual display screen which has not been displayed on the real display screen without any panning operation.

### BRIEF SUMMARY OF THE INVENTION

According to one aspect of the present invention, an information processing apparatus comprises a first display; a pointing device having a second display; means for reflecting a pointing operation of the pointing device to a pointer displayed on the first display; and means for displaying a first image of a virtual screen on the second display.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a perspective view showing an external configuration of an embodiment of information processing apparatus according to the present invention;

FIG. 2 is a block diagram showing an exemplary system configuration of the computer illustrated in FIG. 1;

FIG. 3 is a block diagram showing components of the computer illustrated in FIG. 1;

FIG. 4 shows the relationship between the virtual screen (the entire desk top screen) handled by means of the computer and the real display screen of the embodiment;

FIG. 5 shows the multi-display feature of the embodiment;

FIGS. 6A and 6B illustrate an operation of the embodiment;

FIGS. 7A and 7B illustrate another operation of the embodiment;

FIGS. 8A through 8D illustrate still another operation of the embodiment;

FIGS. 9A through 9F illustrate still further operation of the embodiment:

FIGS. 10A through 10G are still further operation of the embodiment;

FIG. 11 shows a flowchart of the embodiment; and

FIG. 12 shows another flowchart of the embodiment.

### DETAILED DESCRIPTION OF THE INVENTION

An embodiment of an information processing apparatus according to the present invention will now be described with reference to the accompanying drawings.

The following describes an embodiment of a personal computer having not only a display device (main device) for displaying text, graphics, a mouse pointer, etc., but also a display-equipped touch pad type pointing device comprising a display panel (sub display) such as an LCD. The display panel of this pointing device enables a user to display and manipulate various setup and operation screens. One example of a display-equipped pointing device which is available is the cPad™ by Synaptics, Inc., 2381 Bering Dr., San Jose, Calif. 95131. (see http://www.synaptics.com/products/cpad.cfm).

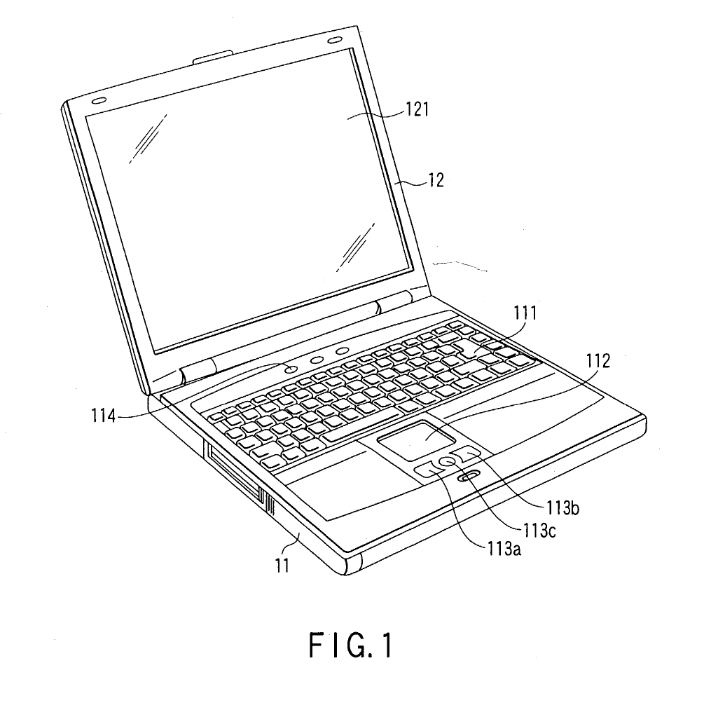

FIG. 1 is a perspective view showing an external configuration of an information processing apparatus according to embodiments of the present invention. FIG. 1 shows an exemplary notebook personal computer in which embodiments of the present invention may be incorporated.

As shown in FIG. 1, the computer according to embodiments of the present invention comprises a computer 11 and a display device 12. The display device 12 includes a display screen (main display) 121 comprising an LCD. The display device 12 is freely rotatively mounted on the computer 11 between opened and closed positions. The computer 11 is formed like a thin box case. A keyboard 111 is arranged on the top surface of the case. An armrest is formed on this top surface between the keyboard 111 and the front end of the case. Almost at the center of the armrest, a display-equipped, touch pad pointing device 112 is arranged together with a left user selectable operator 113a, a right user selectable operator 113b, and a middle user selectable operator 113c which are included in the device 112. The device 112 also works as a sub display.

Further, on the top surface of the computer 11, there is provided a power user selectable operator 114 to turn on or off the computer 11.

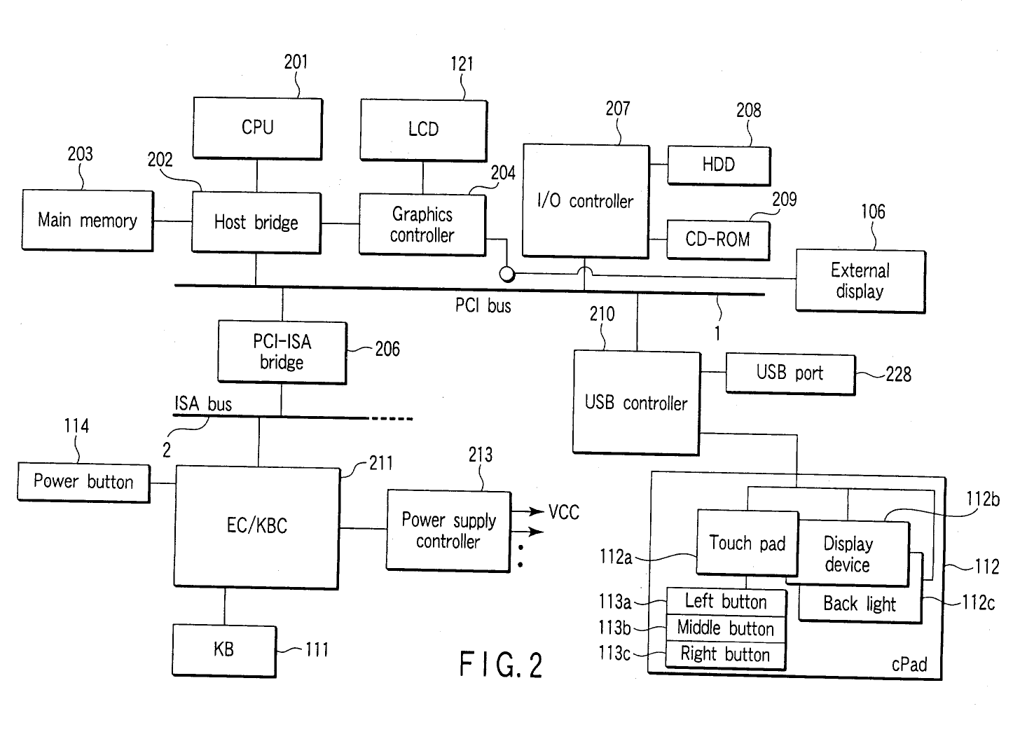

FIG. 2 is a block diagram showing an exemplary system configuration of the computer illustrated in FIG. 1. As shown in FIG. 2, the computer comprises a CPU 201, a host bridge 202, a main memory 203, a graphics controller 204, a PCI-ISA (Peripheral Component Interconnect-Industry Standard Architecture) bridge 206, an I/O (Input/Output) controller 207, a hard disk drive (HDD) 208, a CD-ROM (Compact Disk-Read Only Memory) drive 209, a USB (Universal Serial Bus) controller 210, an embedded controller and keyboard controller IC (EC/KBC) 211, and a power supply controller 213, and the like.

The pointing device 112 and a USB port 228 are connected to the USB controller 210. The pointing device 112 integrally comprises a touch pad 112a, a display device 112b, and a backlight 112c, and includes the left user selectable operator 113a, the right user selectable operator 113b, and the middle user selectable operator 113c.

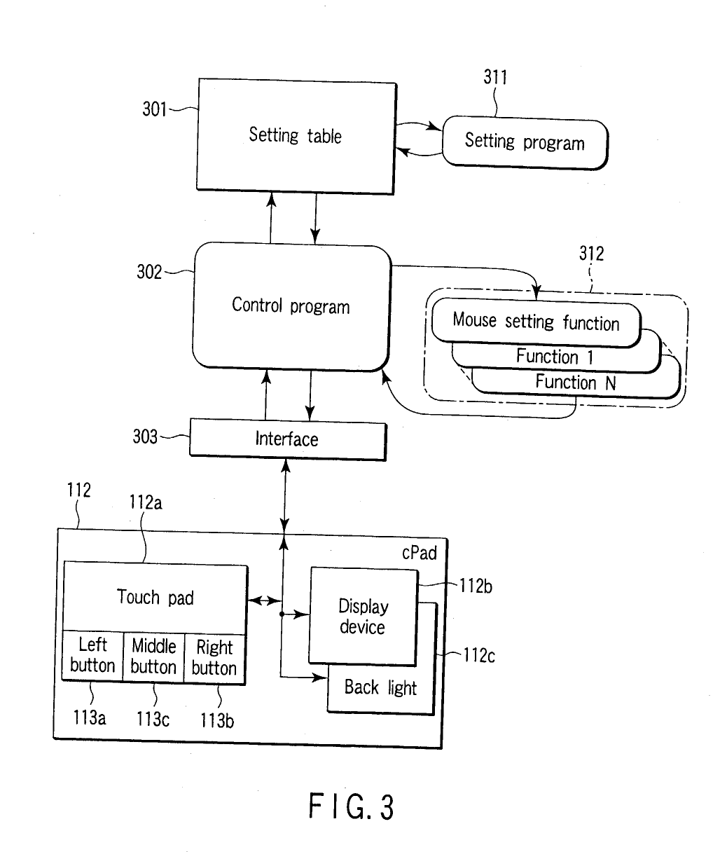

The CPU 201 controls computer operations and executes an operating system, application programs, utility programs and the like which are loaded into the main memory 203 from the hard disk drive 208. The embodiment of the invention shown in FIG. 2 may execute programs shown in FIG. 3. Processing of these programs in FIG. 3 will be described later.

The host bridge 202 is a bridge device to make bidirectional connection between a local bus (not shown) of the CPU 201 and a PCI bus 1. The graphics controller 204 controls a main display (Liquid Crystal Display) 121 used as a display monitor for the computer.

When an external display 106 is connected to the external display connection port, the graphics controller 204 controls the external display 106. When the external display 106 is connected to the external display connection port so that the external display 106 and the main display 121 participates in forming a multi-window display and takes respective parts of a virtual display screen (the entire desk top screen), the graphics controller 204 performs the panning control (control for moving the display areas) which is being conducted for the displayed image which corresponds to the display region specified by a touch operation according to the panning command issued as a result of the touch operation performed for the display region in the entire desk top screen by using the pointing device 112, which will be described hereinafter.

The I/O controller 207 controls the hard disk drive 208, the CD-ROM drive 209, and the like. The PCI-ISA bridge 206 is a bridge device to make bidirectional connection between the PCI bus 1 and an ISA bus 2. In this example, the PCI-ISA bridge 206 includes various system devices such as a system timer, a DMA controller, an interrupt controller, and the like.

The embedded controller and keyboard controller IC (EC/KBC) 211 is a one-chip microcomputer integrating an embedded controller (EC) for power management and a keyboard controller (KBC) for controlling the keyboard 111. The embedded controller and keyboard controller IC (EC/KBC) 211 turns on or off the computer in cooperation with the power supply controller 213 in response to user operation of the power user selectable operator 114.

FIG. 3 is a block diagram showing components of the computer shown in FIG. 1, according to embodiments of the present invention. The components include a setup table 301 for setting up functions of the pointing device 112; a control program 302 for controlling functions of the pointing device 112 according to contents of the setup table 301; an interface 303 for controlling input and output of information interchanged between the pointing device 112 and the control program 302; a setup program 311 for configuring the setup table 301 based on a GUI; an execution module 312 for executing a mouse setup function and functions 1 through N in accordance with commands from the control program 302 and the pointing device 112.

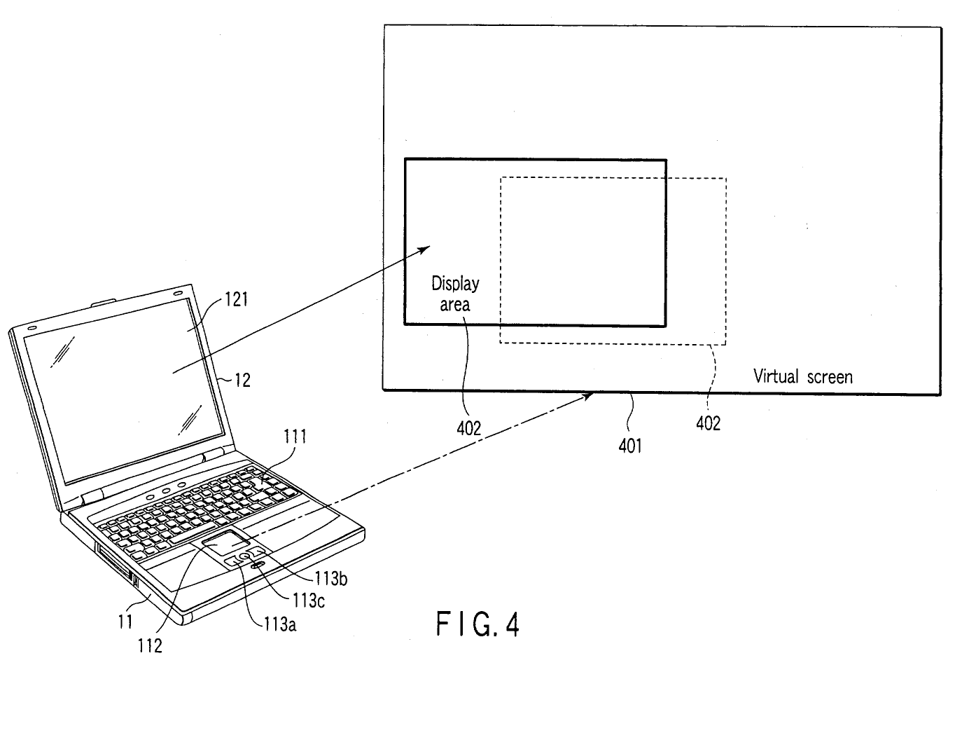

FIG. 4 shows the relationship between the virtual screen (the entire desk top screen) handled by the computer 11 and the real display screen of the embodiment.

The display screen (main display) 121 which comprises LCDs is incorporated in the display device 12 arranged in the computer 11. The display screen 121 is used as display monitor of the computer.

The display screen (real display screen) of the main display 121 displays the image in the display area 402 specified on the virtual screen (entire desk top screen, to be referred to as virtual screen hereinafter) 401. The dimensions (resolution) of the display area 402 are same as the dimensions (resolution) of the display screen (real display screen) of the main display 121. In other words, only the image in the display area 402 is displayed on the main display 121 out of the image of the entire virtual screen 401. The image in the display area 402 is the image of the real display screen of the main display 121. The display area 402 can be moved by a panning operation out of the virtual screen 401 as shown by dotted lines in FIG. 4.

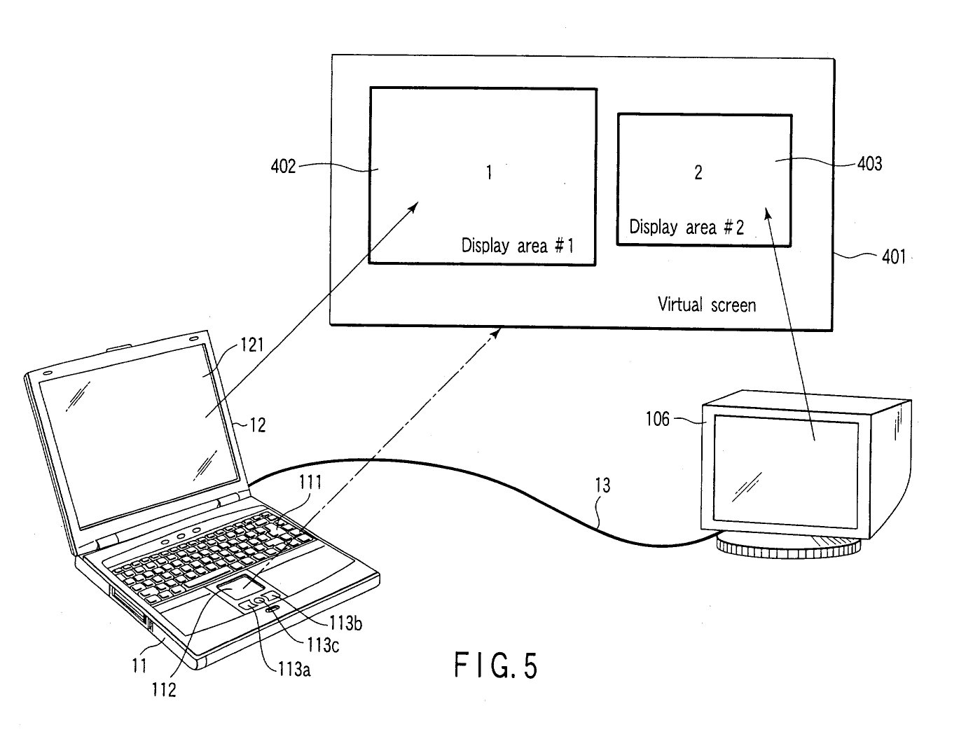

FIG. 5 shows the multi-display feature of the embodiment. The external display 106 is connected to the computer 11 by way of a cable 13. Two display areas of first and second display areas 402 and 403 are arranged on the virtual screen 401. Out of the image of the virtual screen 401, the image of the first display area 402 is displayed on the display screen (first real display screen) of the main display 121 and that of the second display area 403 is displayed on the display screen (second real display screen) of the external display 106. The display areas 402 and 403 can be positioned appropriately on the virtual screen 401 by the panning operation as described above.

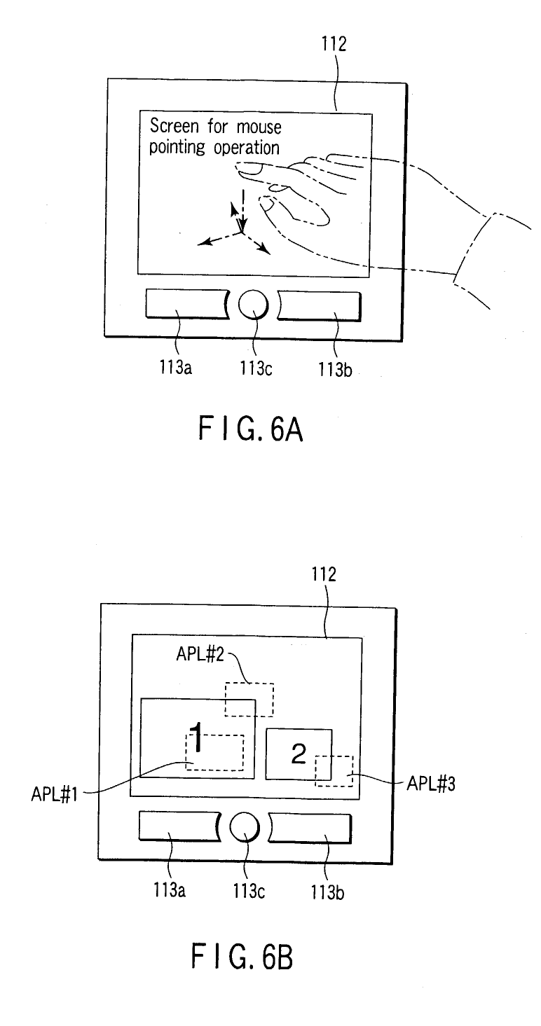

FIGS. 6A and 6B through FIGS. 10A through 10G are illustrations of display modes and a panning operation of the embodiment. The display modes include a non-display mode in which no image is displayed and the pointing device 112 is acting as a mouse or a touch pad, an entire screen display mode in which the entire desk top screen (the virtual screen 401) is displayed on the pointing device 112 at a lower resolution, and a partial display mode in which only a part of the entire desk top screen is displayed on the pointing device 112 at an original resolution. The panning operation includes a panning operation of one of the display screens of a multi-display and a panning operation of an active window.

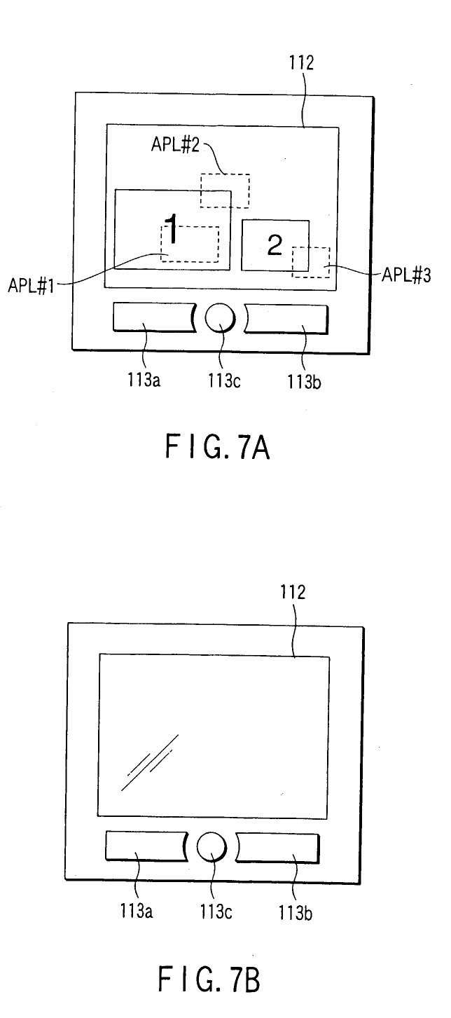

FIGS. 6A and 6B and FIGS. 7A and 7B illustrate a display switching of the pointing device 112. The pointing device 112 can be operated in either of two different display modes. Either of the two display modes of the pointing device 112 can be selected by operating the middle button 113c. The two display modes include the non-display mode (FIG. 6A, FIG. 7B) in which the pointing operation of the pointing device 112 is reflected to the mouse pointer which is displayed on the main display 121 and the entire screen display mode (FIG. 6B, FIG. 7A) in which the entire desktop screen (simplified display screen image of the virtual screen 401) is displayed with rectangular frames which indicate the images being displayed in the virtual screen 401. Though not shown, a mouse cursor is displayed.

In the entire screen display mode, the image being displayed on the main display 121 is indicated by a rectangular frame containing numeral “1” (to be referred to as rectangular frame region “1” hereinafter) and the image being displayed on the external display is indicated by a rectangular frame containing numeral “2” (to be referred to as rectangular frame region “2” hereinafter). The application windows which are currently opened are denoted by symbols APL#1, APL#2, . . . in the virtual screen 401.

Since the application windows which are currently opened are displayed on the pointing device 112, the application can be quickly switched without panning the window into the rectangular frame region “1” in the main display 121.

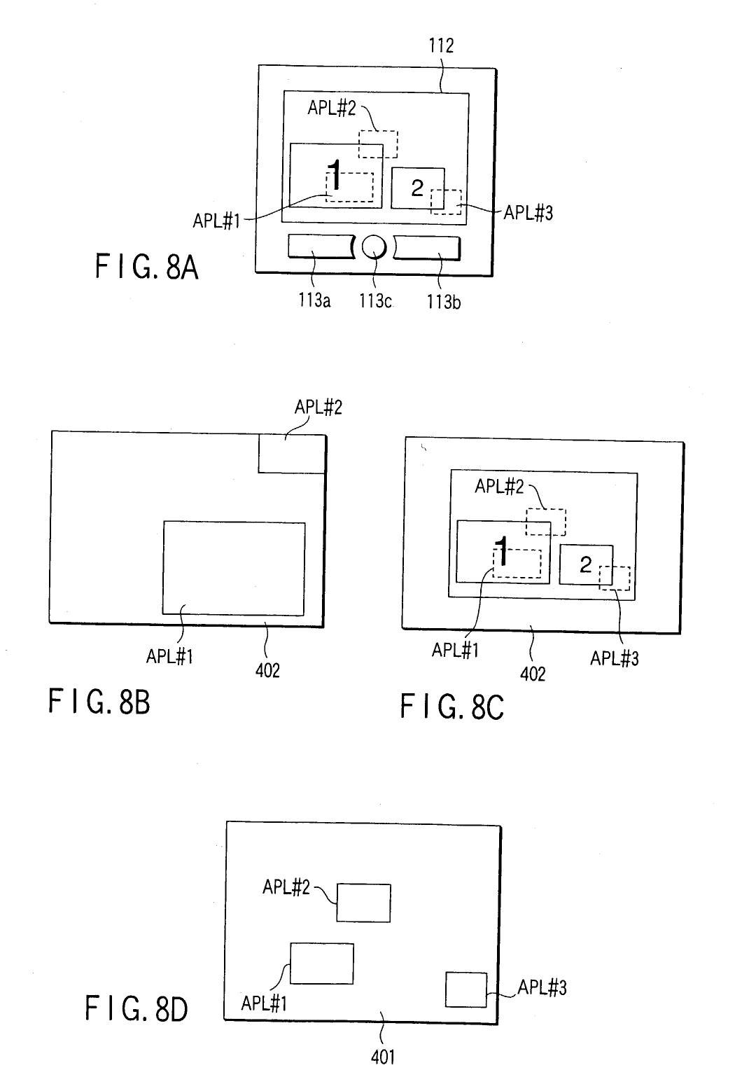

FIGS. 8A to 8D illustrate a switching operation for the display area 402 of the main display 121 according to the multi-display feature of the embodiment. The display area 402 of the main display 121 can be switched by operating the left button 113a and the right button 113 simultaneously. FIG. 8B shows a conventional display mode in which only the rectangular frame region “1” is displayed in the display area 402 of the main display 121. FIG. 8C shows an entire screen display mode in which the entire desktop screen (simplified display screen image of the virtual screen 401) is displayed in the display area 402 of the main display 121. FIG. 8D shows the virtual screen 401 which is not changed even if the main display screen 402 is changed as shown in FIGS. 8B and 8C.

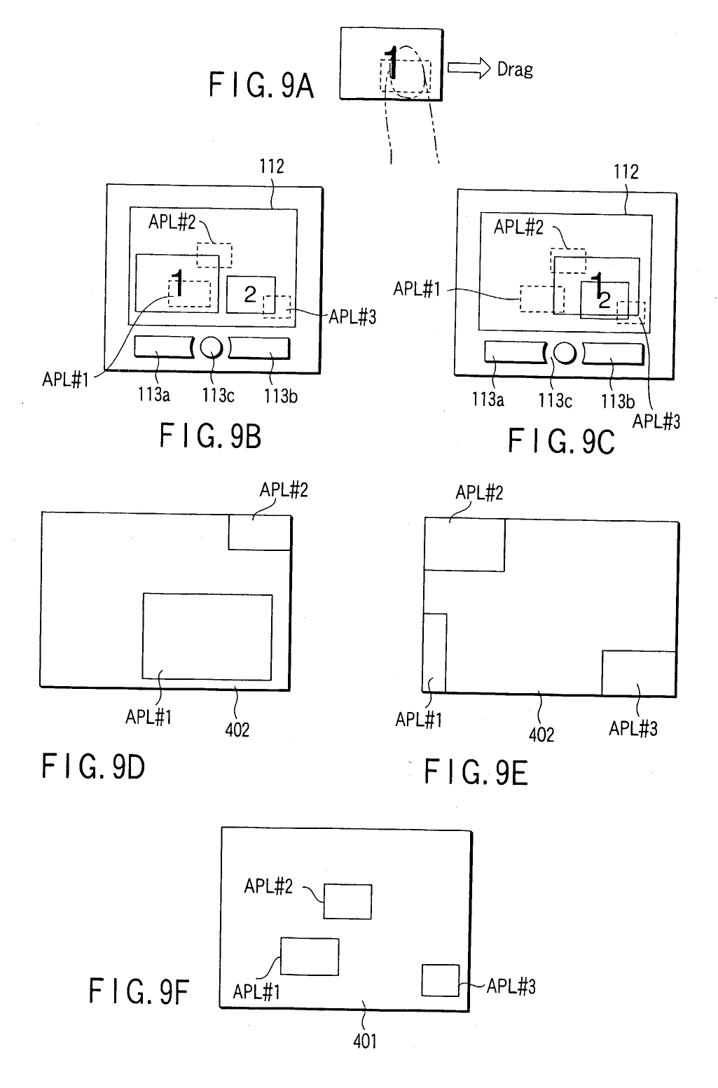

FIGS. 9A through 9F illustrate a panning operation of one of the rectangular frame region “1” and the rectangular frame region “2” on the entire desktop screen displayed on the pointing device 112.

The rectangular region “1” is touched and dragged (moved) in the direction indicated in FIG. 9A. A panning operation is performed to shift the rectangular region “1” in the display screen of the pointing device 112 as shown in FIGS. 9B and 9C. With shifting the rectangular region “1,” the main display 402 of the display device 121 is changed as shown in FIGS. 9D and 9E. However, as shown in FIG. 8F, the virtual screen 401 is not changed even if the main display screen 402 is changed. The display area 402 of the image can be selected by tapping the touch pad 112a in place of dragging (moving) the rectangular region containing numeral “1” by way of a panning (moving) operation.

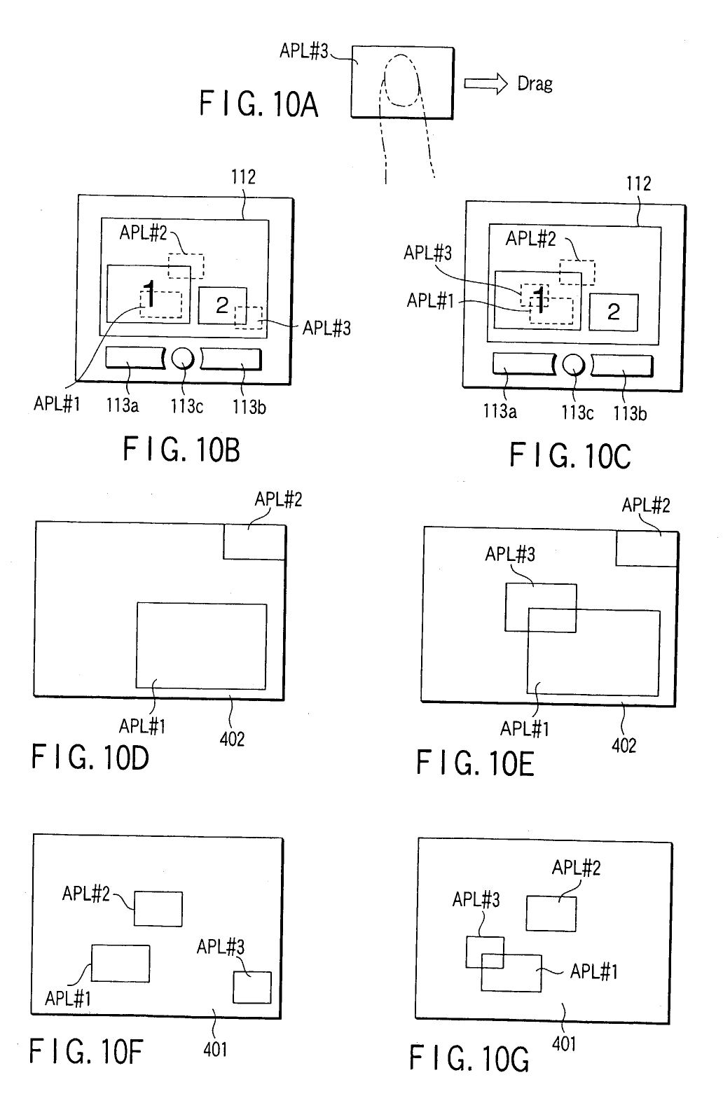

FIGS. 10A through 10F illustrate a panning operation of one of the active windows on the entire desktop screen displayed on the pointing device 112. An application window APL#3 is touched and dragged (moved) in the direction indicated in FIG. 10A. A panning operation is performed to shift the application window APL#3 in the display screen of the pointing device 112 as shown in FIGS. 10B and 10C. With shifting the application window APL#3, the main display 402 of the display device 121 is changed as shown in FIGS. 10D and 10E and the virtual screen 401 is changed as shown in FIGS. 10F and 10G.

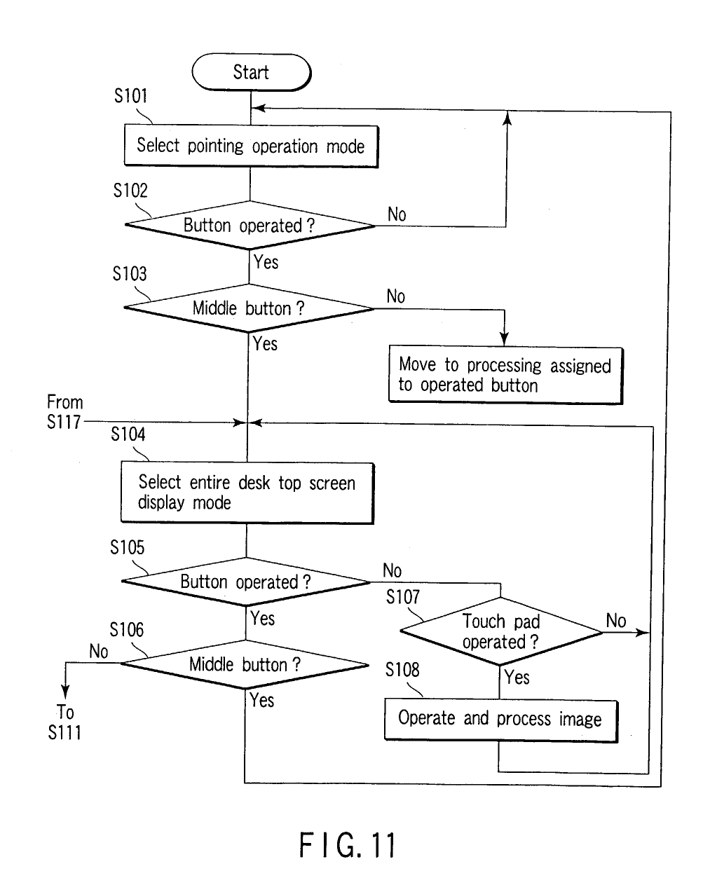

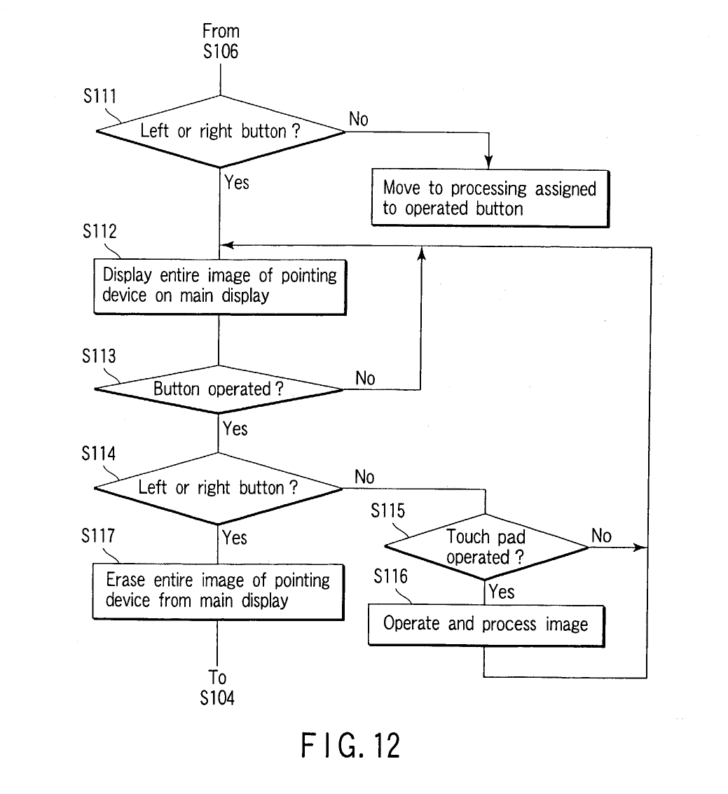

FIGS. 11 and 12 show a flow chart of processing operations of the embodiment, which are conducted by operating the pointing device 112 under the control of the control program 302 shown in FIG. 3. The operations of the embodiment will be described by referring to the related drawings. An operation of selecting the image to be displayed on the entire desk top screen (simplified display screen image of the virtual screen 401) on the pointing device 112 will be described by referring to FIGS. 6A and 6B, FIGS. 7A and 7B and FIGS. 11 and 12.

After the start of the system, the pointing device 112 goes into the operation mode in which the pointing operation of the pointing device 112 is reflected to the mouse pointer which is displayed on the main display 121. The pointing device 112 is used for a mouse pointing operation (step S101). As the middle button 113c of the pointing device 112 is operated in this state (steps S102, S103), the mode of operation of the pointing device 112 is switched from the operation mode as shown in FIG. 6A to the entire screen display mode as shown in FIG. 6B (step S104).

In the entire desktop screen display mode, a simplified image of the virtual screen 401 is displayed on the display device 112b of the pointing device 112 as the image on the entire desktop screen, where the area of the image which is currently being displayed on the main display 121 is indicated by the rectangular frame region “1,” the area of the image which is currently being displayed on the external display is indicated by the rectangular frame region “2” and the windows APL#1, APL#2, . . . which are currently open are indicated by transparent symbols. Thus, as the user sees the image on the entire desk top screen on the pointing device 112, he or she can easily and precisely recognize the location of the area of the image being displayed on the main display 121 (display area 402) in the virtual screen 401, in other words what area of the image on the virtual screen 401 is currently being displayed on the main display 121. Similarly, the user can easily and precisely recognize the location of the area of the image being displayed on the external display 106 (display area 403) in the virtual screen 401.

In the entire desktop screen display mode (step S104), if the middle button 113c of the pointing device 112 is operated again (steps S105, S106), the operation mode of the pointing device 112 is switched back from the entire screen display mode as shown in FIG. 7A to the operation mode (step S101) as shown in FIG. 7B. In this way, as the middle button 113 is operated, the operation mode (step S101) is switched to the entire desktop screen display mode (step S104) or vice versa in an alternating way.

In the entire desktop screen display mode (step S104), the user can perform various operations such as panning operations for the main display 121, panning operations for the external display 106, operations of dragging (moving) a desired application window and so on by way of pointing (touch) operations (steps S107, S108).

For example, as the rectangular frame region “1” is dragged (moved) to the area of the image which is currently being displayed on the main display 121 as shown in FIG. 9A on the pointing device 112 shown in FIG. 9B, the image on the pointing device 112 is changed from the one shown in FIG. 9B to the one shown in FIG. 9C and the image on the main display 121 is changed from the one shown in FIG. 9D to the one shown in FIG. 9E. In this way, as the rectangular frame region “1” is dragged (moved), the area (display area 402) of image which is being displayed on the main display 121 can be moved in a desired direction by means of a panning (moving) operation.

Similarly, as the rectangular frame region “2” shown in FIG. 9B which indicates the area of the image being displayed on the external display 106 is dragged (moved), the area (display area 403) of the image which is currently being displayed on the external display 106 is moved in a desired direction as in the case of a panning (moving) operation conducted for the main display 121.

Additionally, as described above, the area (display area 402) of the image which is being displayed on the main display 121 or the area (display area 403) of the image which is being displayed on the external display 106 can be instantaneously selected by tapping the touch pad 112a in place of a dragging (moving) operation. The image on the virtual screen 401 does not change by a panning operation (see FIG. 9D).

In the entire screen display mode (step S104), any window which is found in the display area 402 of the main display 121 or the display area 403 of the external display 106 can be dragged (moved) to any desired position on the virtual screen 401 by dragging (moving) the window on the pointing device 112. For example, as the application window (APL#3) of FIG. 10A is dragged (moved) on the pointing device 112 as shown in FIG. 10B, the image on the pointing device 112 is changed from the one shown in FIG. 10B to the one shown in FIG. 10C. In other words, the application window (APL#3) is dragged (moved) from a position shown in FIG. 10D to a desired position shown in FIG. 10E in the image shown on the virtual screen 401. The image on the virtual screen 401 changes from the one show in FIG. 10F to the one shown in FIG. 10G as the window is dragged (moved).

In the entire desktop screen display mode (step S104), the user can display, for example, a simplified image of the virtual screen 401 (or the entire desk top screen which is being displayed on the pointing device 112) on the main display 121 by operating a button on the pointing device 112 in addition to the above described operation of switching from the operation mode to the entire screen display mode or vice versa.

When a simplified image of the entire desk top screen is displayed on the pointing device 112 as shown in FIG. 8A in the entire screen display mode (step S104), the image on the entire desk top screen which is being displayed also on the pointing device 112 as shown in FIG. 8A is also displayed on the main display 121 with enlarged dimensions (step S111) as the user operates the left button 113a and the right button 113b arranged on the pointing device 112 simultaneously (step S111). Then, the area (display area 402) of the image being displayed on the main display 121 may change from the one shown in FIG. 8B to the one shown in FIG. 8C. The image on the virtual screen 401 does not change by such an area switching operation (see FIG. 9D).

As a result, the area of the image which is currently being displayed on the main display 121 (display area 402), the area of the image which is currently being displayed on the external display 106 (display area 403) and the arrangement of the windows are displayed on the main display 121 with dimensions greater than those of the image which is being displayed on the pointing device 112 for the convenience of the user. Therefore, the user can easily and accurately recognize the location of the area of the image being displayed on the main display 121 and that of the area of the image being displayed on the external display 106 in the virtual screen 401.

As the left button 113a and the right button 113b arranged on the pointing device 112 are operated simultaneously once again when a simplified image of the virtual screen 401 (or the entire desk top screen) is displayed on the main display 121 (steps S113, S114), the simplified image of the virtual screen 401 (or the entire desk top screen) disappears from the main display 121 (step S117).

When a simplified image of the virtual screen 401 (or the entire desk top screen) is displayed on the main display 121, the user can perform various operations such as panning operations for the main display 121, panning operations for the external display 106, operations of dragging (moving) a desired application window and so on by way of pointing operations (touch operations) conducted on the pointing device 112 (steps S115, S116).

For example, as the user drags (moves) the rectangular frame region “1” which indicates the area of the image being displayed on the main display 121 as shown in FIG. 9A on the pointing device 112 shown in FIG. 9B, he or she can easily and accurately recognize the location of the area of the image being displayed on the main display 121 (display area 402) and that of the area of the image being displayed on the external display 106 (display area 403) in the virtual screen 401.

Additionally, the user can drag (move) any of the various windows (APL#1, APL#2, . . . ) on the virtual screen 401, which may also be found on the display area 402 of the image being displayed on the main display 121 or the display area 403 of the image being displayed on the external display 106, on the pointing device 112 as shown in FIGS. 10A through 10G.

The above described embodiment of the present invention indicates the area of the image being displayed on the display (main display 121) which is taken out of the image being displayed on the entire desk top screen (virtual screen 401) on the pointing device 112 when the user is dealing with the entire desk top screen for the purpose of a panning operation or a multi-display operation. Thus, the user can easily and accurately recognize the area of the image being displayed on the display out of the image on the entire desk top screen. Additionally, the above described embodiment enhances the operability from the user's viewpoint since the image on the entire desk top screen is displayed also on the pointing device 112 and hence the user is free from a situation where he or she cannot clearly see the information being displayed on the main display 121.

Since the area of the image being displayed on the main display 121 and that of the image being displayed on the external display 106 are indicated by rectangular frames, which represent a simple arrangement for indicating the positional relationship of the images, the functional features of the above embodiment can be exploited easily if the resolution of the image displayed on the pointing device 112 is low.

When the area of the image being displayed on the main display 121 and that of the image being displayed on the external display 106 are modified by means of the pointing device 112, the images on the respective displays change correspondingly. Thus, the user can easily and accurately select images to be displayed on the respective displays out of the entire image on the virtual screen 401.

Since the above embodiment indicates the locations of the windows which are being displayed on the main display 121 and the external display 106, the user can easily and accurately recognize the locations of the windows in the entire image being displayed on the virtual screen 401.

Additionally, since the above embodiment indicates the location of a selected one of the windows which are being displayed on the main display 121 and the external display 106, the user can easily and accurately recognize the location of the selected window in the entire image he or she wants to know particularly when a large number of windows are being displayed.

The location of any of the windows which is actually being displayed is shifted by operating the pointing device 112. Therefore, the user can shifts any of the windows located outside the image being displayed on the main display 121 or the external display 106 into the image without modifying the area of image being displayed on the main display 121 or the external display 106, whichever appropriate.

The windows showing the areas of the images being displayed respectively on the main display 121 and the external display 106 in the entire image (being displayed on the virtual screen 401) are indicated by means of transparent symbols. Therefore, the user can see any information being displayed on the windows other than the transparent symbols without problem.

Since the embodiment shows the areas of the images being displayed respectively on the main display 121 and the external display 106 in the entire image (being displayed on the virtual screen 401) by respective windows located at positions close to the pointed region before actually displaying the windows, the user is not required to move the pointed region when performing a panning operation or switching from an image to another by way of the multi-display system. Additionally, since any of the windows can be displayed near the pointed region, the user can operate the embodiment without being forced to shift his or her viewing direction.

The embodiment displays the image on the entire desk top screen (virtual screen 401) either on the pointing device 112 or in a window in a switched manner. Therefore, the image being displayed on the pointing device 112 can be replaced by some other information during a panning operation or a multi-displaying operation without losing the replaced image.

If the area of the image being displayed on the main display 121 or the external display 106 remains on the display, if partly, after selecting some other area of image for display, the pointer is moved automatically to a position close to the remaining area. Therefore, the user is not required to shift the position of the pointer after selecting the other area of image if the area of image which has been displayed on the display remains on the display after the selection of the other area.

While the description above refers to particular embodiments of the present invention, it will be understood which many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An information processing apparatus comprising:
a first display;
a pointing device having a second display;
means for reflecting a pointing operation of the pointing device to a pointer displayed on the first display; and
means for displaying a first image of a virtual screen on the second display.

2. The apparatus according to claim 1, further comprising:
means for selectively activating one of the reflecting means and the means for displaying the first image on the second display.

3. The apparatus according to claim 1, further comprising means for displaying the first image on the first display.

4. The apparatus according to claim 1, further comprising:
means for panning an area of the first display on the first image.

5. The apparatus according to claim 4, further comprising:
means for selectively activating one of the means for displaying the first image on the second display and the panning means.

6. The apparatus according to claim 1, further comprising:
means for displaying on the second display a second image of a virtual screen including a window of an application program; and
means for reflecting a drag operation of the window on the second image to an image displayed on the first display.

7. The apparatus according to claim 6, further comprising:
means for selectively activating one of the means for displaying the second image on the second display and the means for reflecting the drag operation.

8. The apparatus according to claim 1, further comprising:
an external display terminal to which an external display can be connected; and
means for displaying on the second display a third image of a virtual screen including screens of the first display and the external display.

9. The apparatus according to claim 8, further comprising:
means for panning an area of the first display on the third image.

10. The apparatus according to claim 8, further comprising:
means for displaying on the second display a fourth image of a virtual screen including a window of an application program; and
means for reflecting a drag operation of the window on the fourth image to an image displayed on the first display.

11. An information processing apparatus comprising:
a first display;
a pointing device having a second display;
means for reflecting a pointing operation of the pointing device to a pointer displayed on the first display;
means for displaying on the second display an image of a virtual screen including a window of an application program;
means for panning an area of the first display on the image of the virtual screen;
means for reflecting a drag operation of the window on the image of the virtual screen to an image displayed on the first display; and
means for selectively activating one of the means for displaying the image on the second display, the panning means, and the means for reflecting the drag operation.

12. The apparatus according to claim 11, further comprising an external display terminal to which an external display can be connected, and wherein the means for displaying the image on the second display displays on the second display an image of a virtual screen including screens of the first display and the external display and a window of an application program.

13. A control method for an information processing apparatus which comprises a first display, a pointing device having a second display, the method comprising:
reflecting a pointing operation of the pointing device to a pointer displayed on the first display; and
displaying a first image of a virtual screen on the second display.

14. The method according to claim 13, further comprising:
panning an area of the first display on the first image; and
selectively activating one of the first image displaying and the panning.

15. The method according to claim 13, comprising:
displaying on the second display a second image of a virtual screen including a window of an application program;
dragging the window on the second image and reflecting a drag operation to an image displayed on the first display; and
selectively activating one of the second image displaying and the dragging.

16. The method according to claim 13, further comprising:
displaying on the second display a third image of a virtual screen including screens of the first display and an external display.

17. The method according to claim 16, further comprising:
panning an area of the first display on the third image.

18. The method according to claim 16, further comprising:
displaying on the second display a fourth image of a virtual screen including a window of an application program; and
dragging the window on the fourth image and reflecting a drag operation to an image displayed on the first display.

19. The method according to claim 18, further comprising:
reflecting the drag operation to an image displayed on the first display.
